(19) United States
(12) Patent Application Publication
(10) Pub. No.: US 2026/0167033 A1
(43) Pub. Date: Jun. 18, 2026

(54) Charging apparatus for electric vehicles, arrangement, system, use and method

(71) Applicant: Deutsche Post AG, Bonn (DE)

(72) Inventors: Malte Schütt, Cologne (DE); Joao Victor Meneghetti Gambarti Coelho, Miami, FL (US); Laura Camila Gonzalez Sarmiento, Providencia Santiago (CL); Diego Guzmán Madariaga, Santiago (CL)

(21) Appl. No.: 18/986,113

(22) Filed: Dec. 18, 2024

(51) Int. Cl. B60L 53/35; B60L 53/18

(52) U.S. Cl. CPC B60L 53/35; B60L 53/18

(57) ABSTRACT

A charging apparatus for electric vehicles includes a pivot arm with a plurality of longitudinal beam portions and a free end, wherein the plurality of longitudinal beam portions is fixed to one another and are provided for pivotable attachment to a supporting structure, for example, a wall or a beam of a building. The charging apparatus further includes a charging cable guided over the pivot arm and over the free end, which can be connected to an electric vehicle. Additionally, the charging apparatus includes a remote-controllable device for pivoting the pivot arm about a pivot axis for height adjustment of the free end.

The invention relates to a charging apparatus for electric vehicles, the charging apparatus comprising a charging cable which can be connected to an electric vehicle. The invention further relates to an arrangement, a system, a use and a method in conjunction with a charging apparatus.

It is well known that charging apparatuses for electric vehicles are often stationary and inflexible. Such designs are often not universally suitable for the charging requirements of different vehicle types. They also take up a lot of space. This leads to restrictions in charging efficiency, user-friendliness and space utilization, especially when electric vehicles are parked close together.

Based on this, one object of the invention is to provide space-saving, more user-friendly and more efficient solutions for charging apparatuses. The charging apparatus should be easy to maintain, fulfil safety requirements and enable ergonomic cable routing. In particular, it is an object to reduce or avoid disadvantages of known solutions.

This object is achieved by the subject matter of the independent claims. Preferred embodiments of the invention are given in the dependent claims.

In particular, the object is achieved by a charging apparatus for electric vehicles or for an electric vehicle. The charging apparatus has a pivot arm with several longitudinal beam portions and a free end. The longitudinal beam portions are fixed or attached to each other and are provided or set up for pivotable attachment to a supporting structure. The charging apparatus has a charging cable, which is guided over the pivot arm and the free end and can be connected to an electric vehicle, and a remote-controllable device for pivoting the pivot arm about a pivot axis for height adjustment of the free end.

In other words, for example, the problem is solved by an electric vehicle charging apparatus comprising an arm having a plurality of interconnected beams. The beams can be pivotally attached to a building or a supporting structure of a building and/or to a stand, which enables a cantilevered end of the arm to be adjusted in height. A charging cable is guided along the pivot arm and over the projecting end to connect an electric vehicle. The height adjustment can be remote-controllable.

The invention advantageously realizes the idea of creating a charging apparatus that is structurally stable due to the longitudinal beam portions and space-saving and flexible due to the height adjustment by pivoting. In addition, the remote controllability for height adjustment is ergonomically favourable and can keep the time required for height adjustment to a minimum.

The charging apparatus is easy to maintain, particularly due to its height adjustability. The cable is also easier to handle. The invention also improves safety. Potential risks during the charging of electric vehicles are reduced. For example, the charging cable is less likely to be tripped over, damage caused by driving over the charging cable is less likely and crushing of the cable is less likely. A collision with the charging apparatus is also less likely.

A charging apparatus is regularly understood to be a station or device that is intended for final connection to an electric vehicle in order to charge it. The charging apparatus regularly provides at least the charging cable, which can, for example, be held on a beam portion or beam, a pivot arm and/or a column. A mains connection may be provided to supply the charging apparatus with the electricity required for charging. However, the mains connection is not usually part of the charging apparatus. Preferably, the charging apparatus can be connected on the one hand to a mains connection or a supply line and on the other hand to an electric vehicle in order to feed the charging of the electric vehicle from the mains connection.

The charging apparatus regularly interacts with the environment in which the charging apparatus is to be arranged or set up. For example, it may be intended that the charging apparatus is to be attached to a supporting structure of a building, e.g. a wall or a steel beam or girder of the building. For example, a commercially available wallbox for electric vehicles can be attached to a supporting structure of a building, especially if it does not have its own stand.

The supporting structure typically refers to a structure-supporting element, for example of a building, such as a wall, a masonry wall, a steel beam or girder, a visible beam, a stand or the like. The supporting structure is, for example, firmly connected to other components of a building, for example by material and/or form-fit, for example walled in or concreted in or the like. The supporting structure regularly runs horizontally and/or vertically in relation to the ground surface. The supporting structure can start from the ground surface, be placed on it and/or run at a distance from the ground surface. The structure is, for example, a building, such as a house or a hall. The building can also be a column and/or wall, in particular a free-standing one, or at least substantially provide or consist of the supporting structure.

The electric vehicle regularly refers to an electrified motor vehicle or vehicle, in particular a commercial motor vehicle or commercial vehicle. The electric vehicle can be a hybrid-powered or fully electric-powered or battery-powered vehicle. Preferably, the electric vehicle has a battery that can be charged or is to be charged by means of the charging apparatus. The battery may have a usable capacity of at least 10 kWh or at least 25 kWh or at least 50 kWh or at least 75 kWh or at least 100 kWh or at least 200 kWh or at least 300 kWh or more. The electric vehicle can be designed to receive charging power and/or the charging apparatus, in particular the charging cable, can be designed to transmit or provide charging power of at least 2.5 kW or at least 7 kW or at least 20 kW or at least 40 kW or at least 80 kW or more. Maximum values of the usable capacity in kWh or the charging power in kW can be selected equally from the aforementioned values, for example to define value ranges or maximum values. A maximum value can be useful in order to conserve resources by avoiding overdimensioning.

The pivot arm is regularly a structure that is rigid at least in portions and/or elongate in at least one direction, preferably in two directions. It is possible that several or all beam portions of the pivot arm, in particular longitudinal beam portions and/or transverse beam portions, are rigidly connected to each other. For example, the pivot arm is a welded structure, at least in portions. The pivot arm can also have portions that are bolted or detachably connected to each other.

The charging apparatus can have at least one bearing, preferably on the part of the supporting structure, in order to provide the pivot axis. For example, the bearing is connected to the pivot arm on the one hand and is connected or is to be connected to the supporting structure on the other. One of the bearings can be provided for each longitudinal beam portion. The bearings can be spaced apart along the pivot axis, for example by at least 0.5 m or at least 1 m or more. The bearings can be designed to pivot about the pivot axis. The pivot axis preferably runs horizontally or along a ground surface. The pivot axis preferably runs along the respective supporting structure to which the supporting structure is attached or is to be attached. Preferably, the charging apparatus is designed so that the pivot arm can be pivoted about the pivot axis by a pivot angle of at least 10° or at least 15° or at least 20° or more; in this respect, the free end can be adjusted in height.

The pivot arm typically has several longitudinal beam portions, the free end and optionally transverse beam portions. Longitudinal and transverse beam portions, if present, are preferably arranged transversely to each other and preferably fixed to each other in this arrangement, in particular rigidly. A longitudinal member portion or a transverse beam portion can also be referred to as a beam portion. For example, a beam portion is a beam or a portion of a beam or a profile. Preferably, a beam portion has or consists of metal. For example, a beam portion is designed as a metal beam or metal profile or as a portion thereof. For example, the following can be provided as a metal profile: T-profile, H-profile, L-profile, Z-profile, U-profile, rectangular/square profile and/or round profile. For example, a beam portion is hollow and/or rectangular in cross-section, preferably square or rectangular. A steel material and/or an aluminium material can be used as a metal. The pivot arm, in particular the beam portions, can be galvanized. Typically, a beam portion is elongate in one direction. Beam portions can be connected to each other in an integrally bonded and/or form-fit manner, for example welded and/or bolted.

Preferably, at least one of the plurality of longitudinal beam portions forms the free end; for example, a second longitudinal beam portion can form the free end. The plurality of longitudinal beam portions can run at least substantially along a direction between the pivot axis and the free end. The free end is to be understood, for example, in such a way that one of the beam portions cantilevers freely there or can end in a free-floating manner, for example in order to lead the charging cable to the electric vehicle from there. In particular, the pivot arm extends from the pivot axis to the free end.

The charging cable is, for example, a commercially available cable for connecting to electric vehicles. The charging cable is typically intended for AC charging or charging using alternating current and/or for DC charging or charging using direct current. The charging cable has, for example, at least two lines, e.g. copper wires or copper strands, for transmitting charging power and preferably at least one line for data transmission. The charging cable can have a charging plug for plugging into an electric vehicle. The charging cable can be designed to transmit a charging power of at least 2.5 kW or at least 7 kW or at least 20 kW or at least 40 kW or at least 80 kW or more. A maximum value of the charging power in kW can be selected equally from the aforementioned values, for example to define a value range or a maximum value of the charging power. A maximum value can be useful in order to conserve resources by avoiding overdimensioning. The charging cable can be connected or connected to a connection device or wallbox of the charging apparatus.

The device is designed or set up for pivoting the pivot arm. The device can be controlled remotely. For example, the device has an electric motor that can be controlled remotely and can pivot the pivot arm around the pivot axis. For example, the device has a cable winch and/or a lifting cylinder. The device can be controlled remotely by cable or wirelessly. A remote control or remote control can be provided for remote control of the device.

The height of the pivot arm, in particular the free end, can be adjusted by pivoting. Insofar as the pivot axis is substantially parallel and vertically spaced from a surface, a distance between the free end and the surface can be set by pivoting or the free end can be placed on the surface. By pivoting, the pivot arm can bring the free end close to an electric vehicle, e.g. next to the electric vehicle, in order to guide a section of the charging cable extending from the free end to the electric vehicle. By pivoting, the pivot arm and optionally the charging cable can be pivoted away to save space. An electric vehicle can, for example, drive under the charging apparatus.

The pivot device can pivot the pivot arm, in particular into at least two pivot positions, for example into a maintenance position, into a charging position and/or into a standby position. Pivoting can be performed manually and/or steplessly. The maintenance position can bring the free end to the height of an electric vehicle, for example below 2 metres, or substantially to the ground surface or to ground or floor level. In the maintenance position, the charging apparatus can best be maintained from the ground surface, for example to change the charging cable or similar. The charging position can bring the pivot arm into a substantially horizontal position, for example in which the charging cable basically reaches from the free end to the ground surface in order to plug the charging cable into an electric vehicle. The standby position can bring the pivot arm into a substantially horizontal position and/or with the free end pointing upwards. In the standby position, the charging cable can be arranged at a distance from the ground surface, in particular above the electric vehicle, or the charging cable can extend from the free end basically to the ground surface or at a distance from the ground surface. The standby position can be the highest pivot position and the maintenance position can be the lowest pivot position. The charging position can be between the maintenance position and the standby position.

Alternatively or additionally, it may be provided that the pivot arm tapers from the pivot axis towards the free end. For example, the pivot arm is wider in the area of the pivot axis and therefore generally more stable than in the area of the free end. In particular, it is possible that two of the several longitudinal beam portions or first longitudinal beam portions are arranged at an angle or transversely to each other. For example, two first longitudinal member portions are arranged at an angle or transversely to each other. The first longitudinal member portions can converge or taper towards the free end. The pivot arm can, for example, taper by at least 10% or become narrower by at least 10% in the course from the pivot axis to the free end. It has been recognized that the pivot arm is exposed to higher loads close to the pivot axis and lower loads close to the free end, so that a tapered design is typically practical and saves material. The loads are usually caused by tensile force on the charging cable and by air movement or the pivoting movement. Compared to a constant width design, such a taper therefore reduces the weight of the pivot arm and makes it easier to pivot, which can also reduce the load on the supporting structure. A cantilevered length of the pivot arm can therefore be selected longer if necessary.

Alternatively or additionally, it may be provided that the plurality of longitudinal beam portions have two or more first longitudinal beam portions. The plurality of longitudinal member portions, in particular the first longitudinal member portions, or in short: the plurality of/first longitudinal member portions, can point towards the pivot axis, can intersect the pivot axis and/or can end in the pivot axis. For example, the plurality of/first longitudinal member portions are each provided with or connected to a bearing defining the pivot axis in the area of the pivot axis. The plurality of/first longitudinal member portions can intersect the pivot axis opposite the free end along the pivot axis at a distance from one another and/or open into the pivot axis or be provided/connected to the bearing. In this respect, the plurality of/first longitudinal beam portions along the pivot axis can intersect the pivot axis at two points spaced apart from each other or open into the pivot axis, in order to improve the stability of the charging apparatus. This helps to ensure that the charging apparatus is space-saving and can be provided in a material-saving manner.

To save space or material, it may further be provided that the plurality of/first longitudinal beam portions and optionally further beam portions, e.g. longitudinal and/or transverse beam portions, are preferably arranged to extend at least substantially in a common plane. For example, an underside of the pivot arm, typically apart from the charging cable, extends substantially in one plane so that an electric vehicle can be moved safely underneath it. The pivot arm can have an intersection area in which several beam portions are connected or can intersect. The plurality of/first longitudinal beam portions can be connected to each other in the crossing area. The crossing area is located, for example, between the free end and the pivot axis. The intersection area can have at least one reinforcing plate to which two or more of the plurality of longitudinal beam portions can be connected, for example bolted and/or welded. The crossing area can be located closer to the free end than to the pivot axis.

Alternatively or additionally, it may be provided that the plurality of longitudinal beam portions have a further longitudinal beam portion, preferably which can be connected to the first longitudinal beam portions, in particular in the intersection area. The further longitudinal member portion can provide the free end. The plurality of longitudinal member portions, in particular the first longitudinal member portions and the further longitudinal member portion, may extend at least substantially in or along a common plane and/or be arranged in a Y-shape. In the Y-shape, the first longitudinal member portions can form the two Y-legs or Y-arms, and the further longitudinal member portion can form the Y-web or Y-stem. For example, the Y-legs are intended to be attached at their actual free ends in order to pivot around the pivot axis and to allow the Y-bar to cantilever freely. Basically, the other longitudinal beam portion can be held by the two first longitudinal beam portions in order to allow the free end to project as far as possible from the pivot axis. This makes the free end particularly narrow and space-saving. This further increases stability and optimizes load distribution. In the case of forces in a substantially horizontal direction at the free end, i.e. along the pivot axis, for example by pulling on the charging cable, it can be ensured that the structure is stable despite the large distance between the free end and the pivot axis.

It is possible that the further longitudinal beam portion forms a line of symmetry of the pivot arm, to which the first longitudinal beam portions are arranged at an angle and/or opposite each other. The line of symmetry can run from the free end to the pivot axis, in particular intersect the pivot axis approximately in the centre and/or lie approximately in the centre between the first longitudinal member portions. This arrangement improves the stability and increases the load-bearing capacity of the pivot arm, especially in a uniform manner. It also simplifies manufacture.

Alternatively or additionally, it may be provided that the first longitudinal beam portions are connected to each other by means of at least one transverse beam portion of the pivot arm. Two, three or more transverse beam portions are regularly provided, preferably arranged at least substantially parallel to each other and spaced apart. The plurality of longitudinal beam portions and the at least one transverse beam portion, preferably all beam portions, can be connected to each other, in particular rigidly, and/or arranged at least substantially in a common plane. Typically, the at least one transverse beam portion is arranged at least substantially along a transverse direction and the longitudinal member portions are arranged at least substantially along a longitudinal direction. The longitudinal and transverse beam portions are usually arranged transversely, possibly perpendicularly, to each other. For example, the beams are connected to each other, preferably bolted and/or welded. The at least one transverse beam portion can have a lower material thickness than longitudinal member portions and/or be provided with a lower bending stiffness. In this respect, resources can be saved.

Alternatively or additionally, the remote-controllable device may have a cable winch. The cable winch can be attached to the pivot arm. The cable winch, in particular its cable, can be provided for attachment to the supporting structure or a further supporting structure or can be set up for this purpose. The cable winch can be electrically driven or have an electric motor. The cable winch can be designed to receive commands from a remote control and to implement the commands for pivoting the pivot arm. For example, the cable winch can wind and unwind the cable by means of a rotatable winch, in particular to raise or lower the pivot arm with the cable and adjust the height of the free end. The cable winch can have an electromechanical brake. The brake can slow down the cable winch and/or fix it at a standstill. Such an arrangement allows precise height adjustment and safe operation.

Alternatively or additionally, it may be provided that the cable winch is fixed or attached on the one hand between the free end and the pivot axis, preferably between the crossing area and the pivot axis and/or preferably on the first longitudinal beam portions, and preferably on the other hand is provided or set up for attaching above the pivot axis. For example, the cable winch or one end of a cable of the cable winch can be provided for attaching above the pivot axis, for example to the supporting structure or to a further supporting structure. As an example, a rotatable winch of the cable winch, for example a motorized and preferably braked drum for winding up a cable, is located on the pivot arm. One end of a cable of the cable winch can be provided/arranged for attachment above the pivot axis; a reverse arrangement, e.g. with the end of the cable on the pivot arm and the motor on the side of the supporting structure, is also possible. This arrangement increases the efficiency of the power transmission and ensures stable positioning.

The charging apparatus can have at least one mechanical securing means. The mechanical securing means can give way, dampen, break and/or be destroyed, in particular if a load limit is exceeded, in order to release and/or intercept a part of the charging apparatus, in particular the pivot arm, away from the pivot axis in the event of an overload. The securing means can provide a connection between the pivot arm, in particular a superstructure, and a/the supporting structure. In particular, the securing means is a safety cable and/or a damped cable. The safety cable can prevent the pivot arm from falling, for example if the cable breaks or similar. The damped cable can dampen the movement of the pivot arm. It is also possible to provide a predetermined breaking point in the pivot arm. For example, the further longitudinal beam portion can be rotatably connected to the longitudinal beam portions in the crossing area, e.g. parallel to the pivot axis, in particular wherein the securing means is provided as an anti-rotation device that yields or breaks when a certain torque is exceeded as a load limit. For example, a securing means can be integrated into the structure of the charging apparatus, for example in the form of a tension element with a predetermined breaking point, in order to release part of the pivot arm in the event of overloading. For example, the securing means can give way or break if a tensile force of 1000 N or 2000 N or 3000 N or 4000 N or more is applied to the free end via the charging cable.

Alternatively or additionally, it may be provided that no cable drum is provided on the pivot arm. A cable drum is understood to be a device for winding or unwinding a power cable or charging cable; in this respect, this should not be provided on the pivot arm and/or should not be pivoted with it. The charging apparatus can have a/the remote control, in particular to control the remote-controllable device for height adjustment of the free end. This makes pivoting the pivot arm comparatively easy if a cable drum or a device for winding/unwinding is explicitly dispensed with. This simplifies operation and reduces the complexity of the system.

The remote control can, for example, be arranged separately from the charging cable and/or the remote-controllable device. The remote control can communicate wirelessly or by cable with the remote-controllable device. The remote control can also provide an emergency stop switch for the charging apparatus, in particular the remote-controllable device and/or the connection device.

It is possible that the remote-controllable device can be operated via an app on a terminal device, e.g. smartphone or tablet; in principle, the terminal device can then provide the remote control. For example, the remote-controllable device can communicate via Bluetooth, WLAN and/or another communication method, in particular with the remote control or the end device. In particular, the terminal device is separate from the charging apparatus or not part of the apparatus and can, for example, operate several charging apparatuses and/or other apparatuses. In particular, the remote control and/or the terminal device providing the remote control is battery-operated.

It is possible that a remote control is provided for remotely controlling several or all charging apparatuses, particularly in the case of an arrangement or a system, for example a universal remote control, particularly an app on a terminal device. In this respect, a smartphone or tablet can be used as a kind of master remote control to access several or all charging apparatuses.

It is possible that a separate remote control is provided for each charging apparatus, for example a permanently assigned remote control.

In particular, it is possible that both a permanently assigned remote control and a remote control for remotely controlling several or all charging apparatuses are provided, i.e. in principle a redundant selection of remote controls.

Alternatively or additionally, one or more connection devices can be provided for connection, in particular plug-in connection, to the charging cable, or several connection devices, for example two, can be provided for connection or plug-in connection to the charging cable or to several charging cables. The pivot arm can be provided with the connection device or devices. The connection device can have a socket for plugging in the charging cable, in particular several sockets for plugging in several charging cables. The connection device can be set up for the fixed connection of the charging cable in particular, for example with connection terminals and/or a cable bushing. The pivot arm can be provided with the connection device or the connection device can be connected to the pivot arm. The connection device can be a connection box or wall box, in particular which can be provided for connecting and/or plugging in the charging cable. The connection device can be attached to the pivot arm. The connection device can have a rectifier. For example, an electrical supply line or a mains connection leads to the connection device, so that the connection device can provide electrical energy coming from the supply line, in particular in the form of AC voltage and/or DC voltage. In other words, the supply line can be connected to the charging cable, detachably or pluggably or permanently connected or permanently clamped, via the connection device.

For example, the connection device, in particular a socket of the connection device, is located on the pivot arm, in particular between the free end and the pivot axis, in particular into which socket the charging cable can be plugged on the one hand in order to be routed to the electric vehicle on the other.

The connection device or socket or cable feed-through to the charging cable can point towards the free end and/or transverse to the pivot axis. The socket can point longitudinally to the pivot axis and/or transversely to the free end. For example, two sockets pointing away from each other can be provided on the pivot arm. It is possible for a position of the connection device or the socket(s) and/or cable bushing(s) to be adjustable in relation to the pivot arm. In particular, the position of the connection device can vary, for example to charge electric vehicles at the front, on one side or at the rear. For example, the connection device can be arranged rotatably in relation to the pivot arm. In particular, the position of the connection device can be flexibly changed, for example depending on where the charging point of the electric vehicle is located (front, side, rear, etc.). This allows a flexible response to different electric vehicles.

Several charging cables extending from the connection device or from the connection devices can be led down, in particular from the free end, in order to be able to charge several, for example two, electric vehicles. A plug-in direction can point along the longitudinal beam portions, in particular along the further longitudinal beam portion and/or the free end, and/or to the free end and/or transversely to the pivot axis. The plug-in direction can be transverse to the longitudinal beam portions and/or transverse to the free end and/or along the pivot axis. A connection or plug-in connection between the connection device and charging cable can be released by tensile force, in particular substantially in the plug-in direction. For example, the tensile force required to release the connection or plug-in connection is at least 30 N or at least 40 N or at least 50 N or more.

It is possible that the attachment of the connection device to the pivot arm is designed in such a way that it is released and/or destroyed when a tensile force of 500 N or 1000 N or 1500 N or 2000 N or more is applied in the longitudinal direction in order to release the connection device and prevent further damage to the charging apparatus or the electric vehicle or even the pivot arm falling down. It is also conceivable to design the charging cable in such a way that it is split at a predetermined breaking point at a tensile force of 500 N or 1000 N or 1500 N or 2000 N or more.

The charging cable can be deflected at the free end, in particular longitudinally. A guide for the charging cable can be provided at the free end, which can, for example, deflect the charging cable in a vertical direction starting from the free end. The guide can be designed to prevent the charging cable from chafing and/or kinking. The guide can, for example, be made of a slippery plastic, such as PTFE, or have a slippery coating. The aforementioned features improve flexibility, facilitate connection and increase safety.

Alternatively or additionally, the pivot arm can be provided for attachment at a height of at least 2 metres and/or up to 8 metres. Preferably, a mounting at a height of 4 m±1 m or m±1 m is provided. In particular, the pivot axis is located at this height. The height typically refers to an at least substantially vertical distance from the ground surface. The pivot arm can have a length of at least 5 m and/or up to 15 m. Preferably, a length of 8 m±4 m, 9 m±4 m, 10 m±4 m or 11 m±4 m is provided. In particular, the length should be measured from the pivot axis to the free end. Depending on a pivot position or a pivot angle of the pivot arm, the length regularly runs along the ground surface or parallel to the ground surface. This makes it possible to use the charging apparatus for different vehicle types and locations. Typically, the position of a charging socket or socket, also known as a charging point on the electric vehicle, for plugging in the charging cable on electric vehicles is not standardized.

Furthermore, an arrangement with or comprising a plurality (of) charging apparatuses is proposed, wherein at least some or all of the plurality of charging apparatuses are arranged or are to be arranged adjacent to one another and/or with substantially coaxially aligned pivot axes, in particular to form a common pivot axis. Alternatively or additionally, at least some or all of the plurality of charging apparatuses are arranged or are to be arranged opposite one another or with the free end pointing towards or away from one another and/or with substantially parallel aligned pivot axes. In this respect, charging apparatuses can be provided next to each other for parallel, preferably coaxial, pivoting and enable space-saving charging of electric vehicles.

In particular, the problem is solved by a system with a supporting structure and at least one charging apparatus attached to the supporting structure. The system may comprise the arrangement described herein. The charging apparatus may be as described herein. The system may comprise a building that forms or provides the supporting structure. The system or structure may provide the ground surface, wherein the ground surface preferably extends at least substantially parallel to the pivot axis. The system can comprise several of the charging apparatuses, which are in particular attached to the same supporting structure and/or are provided for pivoting about a common pivot axis, in particular in order to connect electric vehicles parked next to each other or to be able to charge them with the charging apparatus. It is possible that the charging apparatuses are attached to several/different supporting structures. For example, the charging apparatuses are arranged above parking spaces for electric vehicles to be charged in order to be pivoted from above towards the parking spaces and upwards away from them. In particular, it is conceivable that a charging apparatus is arranged in such a way that the free end is arranged substantially above an edge of a respective parking space so that it can be pivoted in next to an electric vehicle or between two electric vehicles.

Furthermore, a use of a/the charging apparatus for an electric vehicle or for charging the electric vehicle is proposed, in particular wherein the electric vehicle is designed as a commercial vehicle. The use can relate in particular to the arrangement or the system. The charging apparatus can be attached to a supporting structure of a building. The supporting structure can be a wall or a beam of the building. The use can be advantageously designed with the same or similar features as the charging apparatus or the system or the arrangement.

Furthermore, a method for pivoting a pivot arm of a/the charging apparatus is proposed. The method may in particular relate to the arrangement or system. The remote-controllable device can be controlled by means of a/the remote control to pivot the pivot arm about a/the pivot axis. By pivoting, a/the free end of the pivot arm can be adjusted in height. The remote control can send a control command to the device, in particular to a cable winch of the device, preferably wirelessly or by cable. It is possible to choose from at least two or three or more pivot positions. It is possible for the pivot arm to be pivoted manually and/or steplessly.

In the context of the disclosure, the term “or” is intended, for example, to indicate alternative, substantially equivalent and/or synonymous features, ideas or terms in order to bring the idea or meaning of a feature or term use closer. The term “or” can be replaced with “and/or”.

In the following, the invention is explained in further detail with reference to the drawings by means of a preferred exemplary embodiment.

### THE DRAWINGS SHOW

FIG. 1 a system with a supporting structure and with a charging apparatus attached to the supporting structure and having a pivot arm, wherein the charging apparatus is shown in various pivot positions,

FIG. 2 a system with several supporting structures and with a charging apparatus attached to the several supporting structures, wherein electric vehicles to be charged are arranged below the charging apparatus

FIG. 3 the system shown in FIG. 2, wherein the charging apparatus is pivoted towards the ground surface, and

FIGS. 4A-E further views of the system from FIG. 2, and

FIG. 5 a general view of the system shown in FIG. 2.

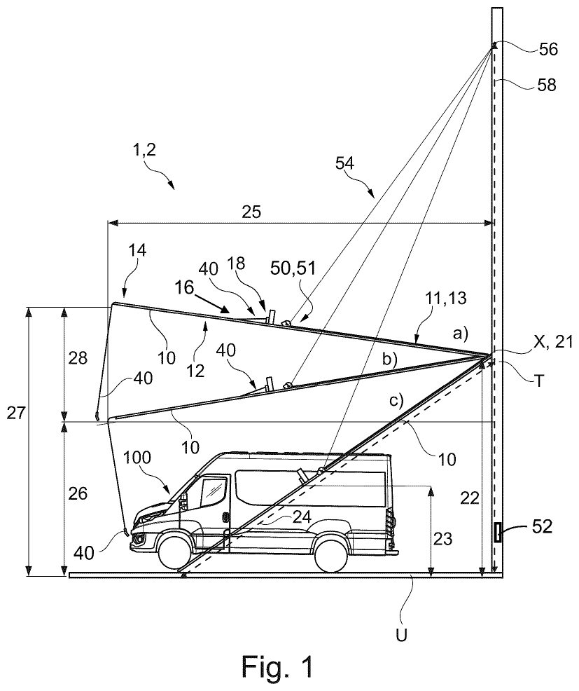

FIG. 1 shows a system 1 with a supporting structure T and with a charging apparatus 2 attached to the supporting structure T is shown. The supporting structure T extends at least substantially vertically from a ground surface U and is, for example, a wall or a beam or steel girder, in particular of a building. The building is formed, for example, with the supporting structure T. The building can be part of the system 1.

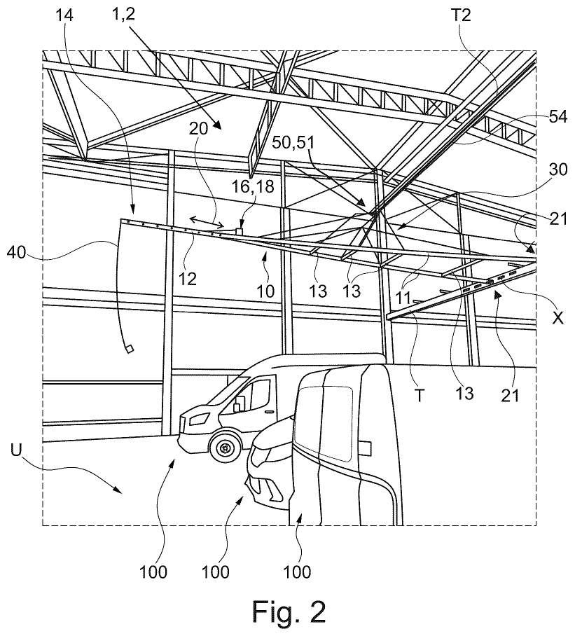

FIG. 2 shows a further system 1 that is very similar to that in FIG. 1, so that the description of FIG. 1 applies in principle in the same way.

With reference to FIG. 1, it can be seen that an electric vehicle 100 to be charged is standing on the ground surface U, which is a commercial vehicle, for example with a permissible payload or payload of at least 500 kg or at least 1000 kg or at least 1500 kg.

The electric vehicle 100 is battery-powered in the present case. The battery of the electric vehicle 100 has a usable capacity of at least 10 kWh.

The charging apparatus 2 can be pivoted about a pivot axis X in order to adjust the height of a free end 14 of the charging apparatus 2.

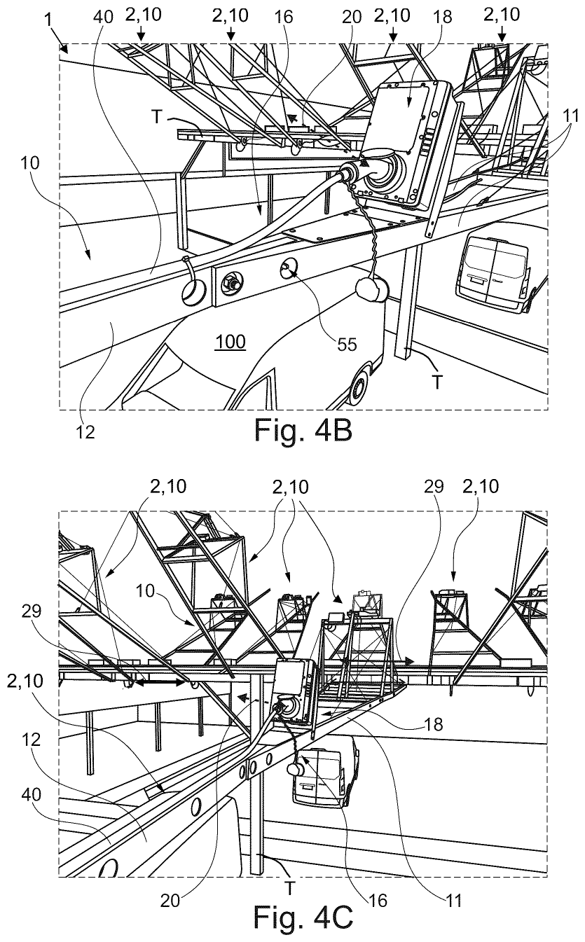

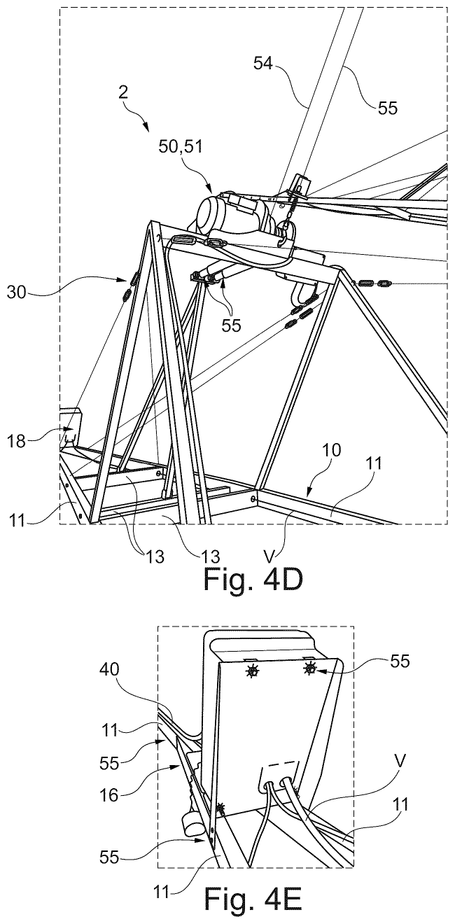

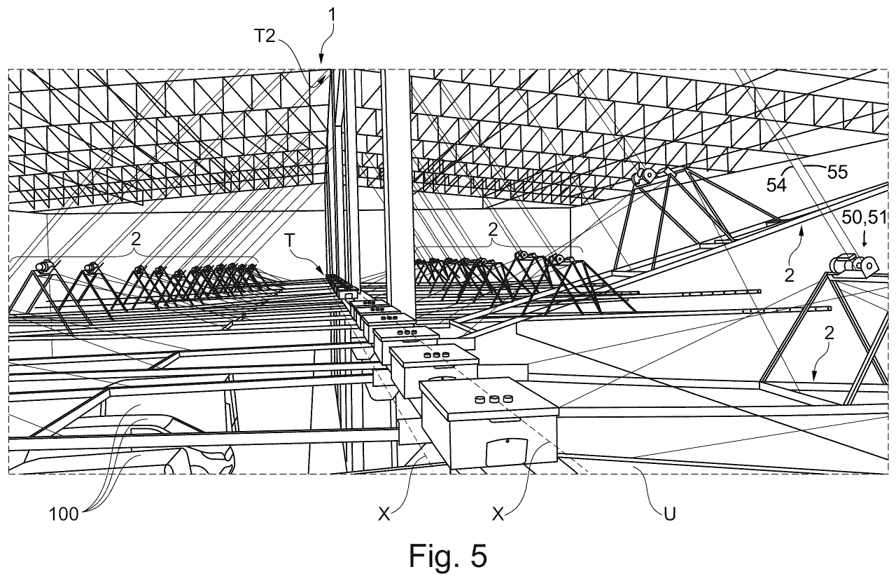

Several of the charging apparatuses 2 can be attached to the supporting structure T and, in particular, can be provided for pivoting about the pivot axis X as a common pivot axis X in order to connect electric vehicles 100 parked next to one another to the charging apparatuses 2, cf. also FIG. 4 and FIG. 5 as views of FIG. 2.

The charging apparatus 2 has a pivot arm 10 with several longitudinal beam portions 11, 12 and the free end 14. The plurality of longitudinal beam portions 11, 12 are fixed to one another and are provided for pivotable attachment to the supporting structure T or are attached to it.

The charging apparatus 2 has a charging cable 40, which is routed over the pivot arm 10 and over the free end 14, and which can be connected to an electric vehicle 100. The charging cable 40 is flexible and can transmit a charging power of at least 2.5 kW, for example by means of direct current or DC or alternating current or AC.

In FIG. 1, the charging cable 40 is shown in various pivot positions of the charging apparatus 2 in simplified form as protruding vertically from the pivot arm 10, wherein the charging cable 40 can also be brought into other positions without damage due to its flexibility.

The charging apparatus 2 has a remote-controllable device 50 for pivoting the pivot arm about the pivot axis X to adjust the height of the free end 14.

In particular, the pivot arm 10, in this case together with the charging cable 40 and the remote-controllable device 50, can be pivoted about the pivot axis X.

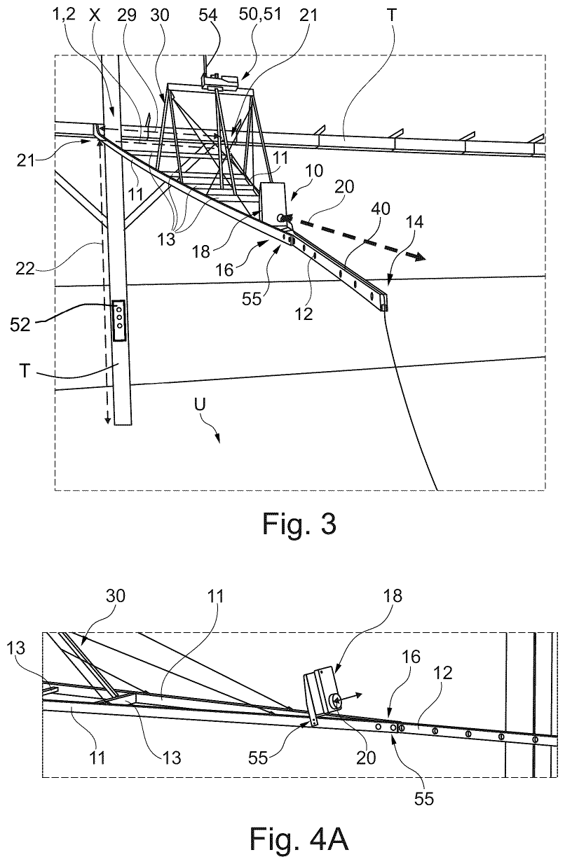

The pivot arm 10 tapers from the pivot axis X towards the free end 14, see also FIG. 2, FIG. 3, FIG. 4 and FIG. 5.

The plurality of longitudinal beam portions 11, 12 have two first longitudinal beam portions 11 arranged in a common plane, which point towards the pivot axis X and basically intersect the pivot axis X. Bearings 21 connected to the first longitudinal beam portions 11 and the supporting structure T are provided, which define the pivot axis X and enable low-friction pivoting or a pivotable attachment of the pivot arm 10 to the supporting structure T.

The several longitudinal beam portions 11, 12 are connected to each other at least in a crossing area 16 located between the free end 14 and the pivot axis X.

The plurality of longitudinal beam portions 11, 12 have a further longitudinal beam portion 12 connected to the first longitudinal beam portions 11 in the intersection area 16, which provides the free end 14. The first longitudinal member portions 11 and the further longitudinal member portion 12 extend along the common plane and are arranged in particular in a Y-shape.

The first longitudinal beam portions 11 are connected to each other by means of at least one transverse beam portion 13 of the pivot arm 10. The plurality of longitudinal beam portions 11, 12 and the at least one transverse beam portion 13 are rigidly connected to one another.

The remote-controllable device 50 has a cable winch 51, which is fixed to the pivot arm and which is attached to the supporting structure T, see also FIG. 4D.

The cable winch 51 is, in particular on the one hand, fixed to the pivot arm 10 between the free end 14 and the pivot axis X, preferably between the crossing area 16 and the pivot axis X or to the first longitudinal beam portions 11, on the pivot arm 10. The cable winch 51 is furthermore provided, in particular on the other side, for attachment above a/the pivot axis X or is attached to the supporting structure T or a further supporting structure T2.

The cable winch 51 is arranged on a superstructure 30 on the pivot arm 10. The cable winch 51 is attached to the superstructure 30, for example to a transverse beam of the superstructure 30. The transverse beam of the superstructure 30 is secured to the pivot arm via supports of the superstructure 30. In the present case, the superstructure 30 is further secured by tensioning cables stretched between the pivot arm 10 and the superstructure 30, see also FIG. 4D.

In particular, a cable 54 of the cable winch 51 is attached to the supporting structure T at a height 58 at an attachment point 56. The height 58 is, for example, at least twice as much as a height 22 of the pivot axis X.

The cable winch 51 has an electric motor that can rotate a drum that winds or unwinds the cable 54.

The cable winch 51 has an electromechanical brake that brakes or fixes the drum when it is at a standstill and/or when it reaches a standstill. When the brake is de-energized, the brake is generally closed in order to fix the drum.

In the present case, no cable drum is provided on the pivot arm 10. As an example, the charging apparatus 2 has a remote control 52 for controlling the remote-controllable device 50 for height adjustment of the free end 14. The remote control 52 is set up to send a command for pivoting to the remote-controllable device 50, which the latter can implement. For example, the remote control 52 is a remote control, e.g. radio remote control or wired remote control. The remote control 52 can communicate wirelessly or by cable with the device 50 or the cable winch 51. The remote control 52 is battery-operated, for example.

For example, the remote control 52 is arranged on the supporting structure T and/or separately from the remaining parts of the charging apparatus 1. For example, a holder may be provided for the remote control 52, for example wherein the holder is provided on the supporting structure T and/or wherein the remote control 52 can be optionally detached from the holder, regardless of whether the remote control 52 operates wirelessly or wired. In FIG. 3, the remote control 52 is detachably held on the supporting structure T and can be removed manually, in particular when it is being operated.

For example, the remote control 52 is magnetic in order to be detachably held on a metal support, in particular the supporting structure T.

The remote control 52 can have several control buttons in order to operate at least the remote-controllable device 50, see FIG. 3.

The remote control 52 can have an operating button for pivoting upwards and an operating button for pivoting downwards.

The remote control 52 can have a main switch or emergency stop switch, which can switch off the remote-controllable device 50 and/or a connection device 18.

The remote control 52 may have an on/off switch to switch the remote control 52 itself on and off.

The pivot arm 10 is provided with a connection device 18 for connecting, in particular plug-in connection, to the charging cable 40. The connection device 18 is basically designed as a wallbox and has a socket into which the charging cable 40 can be plugged along a plug-in direction 20, see also FIG. 3 and FIG. 4. The plug-in direction 20 is orientated at an angle to the free end 14, for example to facilitate plugging in and/or to counteract an angle in the charging plug of the charging cable 40.

It is also possible for the connection device 18 to be permanently connected to the charging cable 40, for example wherein the charging cable 40 in the connection device 18 is at least indirectly connected to the supply line V. In this case in particular, the plug-in direction 20 corresponds, for example, to the direction of a cable feed-through.

The connection device 18 can have a rectifier. In the present case, the connection device 18 does not have a rectifier or is designed without a rectifier and/or inverter because only AC charging is provided. This saves weight.

The plug-in direction 20 of the connection device 18 points substantially along the longitudinal member portions 11, 12 and/or towards the free end 14. A connection or plug-in connection between the connection device 18 and the charging cable 40 can be released by a tensile force of at least 50 N, for example, in the plug-in direction 20. The charging cable 40 is deflected at the free end 14, in particular longitudinally movable.

The attachment of the connection device 18 to the pivot arm 10 is designed such that it is released and/or destroyed by a tensile force in the longitudinal direction of the free end 14 of 2000 N or more, in order to release the connection device 18.

The connection device 18 can be riveted to the pivot arm 10 transversely to the further longitudinal beam portion 12 and/or transversely to the plug-in direction 20, so that a rivet can be sheared off in the plug-in direction 20 if there is sufficient tensile force. The riveting provides a mechanical securing means 55 that yields or is destroyed if a load limit is exceeded, see also FIG. 4A.

The connection device 18 can detach from its holder on the pivot arm 10 with sufficient tensile force, for example by tearing out screw connections. This also provides a mechanical securing means 55. See also FIG. 4E, in which a rear side of the connection device 18 screwed to a holder of the pivot arm 10 is shown.

The charging apparatus 2 is provided at a height 22 of at least 2 m and up to 8 m. The charging apparatus 2, in particular the pivot arm 10, has a length has a length 24 of at least m and up to 14 m.

A use of a charging apparatus 2 for an electric vehicle 100, in particular a commercial vehicle, is illustrated and described. The charging apparatus 2 is attached to a supporting structure T of a building. The supporting structure T is a wall or a beam of the building.

It is possible that the charging apparatus 2 has the supporting structure T. For example, the supporting structure T can be a column or a stand, e.g, for attaching to or placing on a ground surface U.

A charging apparatus 2 is shown and described, with which a method for pivoting a pivot arm 10 of the charging apparatus 2 can be carried out, wherein a remote-controllable device 50 of the charging apparatus 2 is controlled by means of a remote control 52 in order to pivot the pivot arm 10 about the pivot axis X, and wherein a free end 14 is adjusted in height by the pivoting.

The charging apparatus 2 can be pivoted between a standby position, see a) in FIG. 1, a charging position, see b) in FIG. 1, and a maintenance position, see c) in FIG. 1, in particular by remote control.

In the maintenance position, a height 23 of the crossing area 16 and/or a height of the connection device 18 and/or a height of the remote-controllable device 50 is preferably accessible from the ground surface U or at least easily accessible, e.g. by means of a ladder. For example, the height 23 of the crossing area 16 in the maintenance position is 2 m±1 m.

For example, a length 25 of the pivot arm 10 projected in plan view onto the ground surface U, in particular in the standby position and/or in the charging position, is preferably 9 m±2 m. For example, a height 26 of the pivot arm 10 in the charging position is preferably 3.5 m±1.5 m. For example, a height 27 of the pivot arm 10 in the stationary position is preferably 6 m±1.5 m. A height difference 28 between the standby position and the charging position, for example measured at the free end 14, is preferably 2.5 m±1.5 m.

The system 1 shown in FIG. 2, which also comprises an arrangement with charging apparatuses 2, is shown in further views in FIG. 3, FIG. 4 and FIG. 5.

The arrangement shown in particular in FIG. 5 comprises several of the charging apparatuses 2. Some of the charging apparatuses 2 are arranged next to one another with coaxially aligned pivot axes X. Some of the charging apparatuses 2 are arranged opposite each other and with parallel aligned pivot axes X for pivoting about a common pivot axis X. Basically, one row of charging apparatuses 2 are arranged on one side of the supporting structure T and a second row of charging apparatuses 2 are arranged on the other side of the supporting structure T to face away from each other with the free ends 14. The arrangement makes it possible to charge a large number of electric vehicles 100 in a small space.

In FIG. 2, the charging apparatus 2 is attached to two different supporting structures T, T2. In particular, the cable 54 of the remote-controllable device 50 is attached to a further supporting structure T2 and the pivot axis X on the pivot arm 10 is formed with the supporting structure T below the further supporting structure T2. As an example, the further supporting structure T2 is a support on a ceiling of a building.

Furthermore, the charging apparatus 2 of FIG. 2 has the structure 30, which gives the pivot arm 10 stability and serves to attach the remote-controllable device 50. The superstructure is, for example, a supporting structure or structure consisting of beams or supports.

Furthermore, the charging apparatus 2 has various mechanical securing means 55 which can give way and/or be destroyed if a load limit is exceeded in order to release and/or catch the pivot arm 10 away from the pivot axis X in the event of an overload.

A mechanical securing means 55, cf. FIG. 3 and FIGS. 4A-B, provides an anti-rotation lock between the further longitudinal beam portion 12 and the longitudinal beam portions 11, in particular in the crossing area 16, which breaks when a certain torque is exceeded as a load limit, for example when a tensile force of 1000 N or more is applied at the free end 16 via the charging cable 40. In particular, the connection of the longitudinal beam portions 11, 12 in the crossing area 16 can be designed in such a way that it is separated and/or released when a tensile force of 1000 N or 2000 N or 3000 N or 4000 N or more is applied, for example transversely to the free end 14 and about the pivot axis X, in particular in order to release the free end 14.

Further mechanical securing means 55, see FIG. 4D, provide a connection between the pivot arm 10, in particular the superstructure 30, and the further supporting structure T2. In particular, a securing means 55 is a safety cable and/or a damped cable. The safety cable can prevent the pivot arm 10 from falling, for example if the cable 54 breaks or similar. The damped cable can dampen the movement of the pivot arm 10. Another securing means 55, for example a tension element, in particular integrated in the structure 30, can give way when a load limit is exceeded in order to release a part of the structure 30 and a part of the pivot arm 10 on the part of the free end 14.

It is evident that the first longitudinal member portions 11 are connected to at least one, in particular three or more, transverse beam portions 13. Typically, the longitudinal beam portions 11, 12 and the transverse beam portions 13 are, at least partially, bolted and/or welded metal profiles or metal beams.

The first longitudinal beam portions 11 and the further longitudinal beam portion 12 clearly form a Y-shape with the intersection area 16.

The remote-controllable device 50 is arranged between the intersection area 16 and the pivot axis X on the pivot arm 10, in particular on the superstructure 30.

The charging cable 40 is guided on the further longitudinal beam portion 12 or at the free end 14 in the plug-in direction 20 and can hang down from there via the free end 14 substantially perpendicular to the ground surface U, for example in order to be plugged into an electric vehicle 100 for charging.

The electric vehicle 100 has a charging socket for plugging in the charging cable 40. The charging socket can be arranged at the rear, at the front and/or on one side of the electric vehicle 100.

The charging cable 40 is plugged into the connection device 18 in the intersection area 16 along the plug-in direction 20 or inserted into the connection device 18. When the charging cable 40 is pulled, for example when an electric vehicle 100 connected to it is moved away from the charging apparatus 2, a tensile force can be transmitted to the connection device 18 along the charging cable 40 or along the plug-in direction 20. In this case, the connection, in particular the plug connection, to the connection device is disconnected even with a tensile force of only 50 N, so that the charging cable 40 ca substantially be released and removed from the charging apparatus 2. This prevents the pivot arm 10 from being damaged or its attachment to supporting structures T, T2 from becoming unintentionally detached.

For example, the free end 14 has a guide for the charging cable 40, which substantially deflects a tensile force on the charging cable 40 in the plug-in direction 20.

An electrical supply line V or a mains connection, shown as an example in FIGS. 4D-E, leads to the charging apparatus 2, in particular to the connection device 18. This allows an electric vehicle 100 to be charged with electrical energy from the supply line V via the charging cable 40. For example, the supply line V is connected on the one hand to a public power grid and on the other hand to the connection device 18 and/or the charging cable 40.

FIG. 3 shows the system 1 of FIG. 2, wherein the pivot arm 10 is in a lower pivot position, for example between a maintenance position and a charging position or in a maintenance position. The description of FIG. 2 applies in principle in the same way.

It can be seen that the first longitudinal beam portions 11 end in the pivot axis X, in this case spaced apart along the pivot axis X by a distance 29. The distance 29 is, for example, at least 0.5 m or at least 1 m or more. In particular, the bearings on the first longitudinal beam portions 11 are spaced apart by the distance 29.

For example, the free end 14 is spaced from the pivot axis X by the length 24 or the pivot arm 10 is as long as the length 24.

A ratio of the distance 29 to the length 24 is, for example, at least 0.03 or at least 0.05, preferably at least 0.1, more preferably at least 0.15, in order to create good stability and connection to supporting structures T, T2.

Preferably, a length of the further longitudinal beam portion 12 is less than a length of one of the first longitudinal beam portions 11, for example by at least 10% less.

List of reference signs

| | |
|---|---|
| 1 | system |
| 2 | charging apparatus |
| 10 | pivot arm |
| 11 | first longitudinal beam portions |
| 12 | further longitudinal beam portion |
| 13 | transverse beam portion |
| 14 | free end |
| 16 | crossing area |
| 18 | connection device |
| 20 | plug-in direction |
| 21 | bearing |
| 22 | height of the pivot axis |
| 23 | height of the crossing area |
| 24 | length |
| 25 | projected length |
| 26 | height in charging position |
| 27 | height in standby position |
| 28 | height difference between 26 and 27 |
| 29 | width |
| 30 | structure |
| 40 | charging cable |
| 50 | remote-controllable device |
| 51 | cable winch |
| 52 | remote control |
| 54 | cable |
| 55 | securing means |
| 56 | attachment point |
| 58 | height of 56 |
| 100 | electric vehicle |
| a) | standby position of 10 |
| b) | charging position of 10 |
| c) | maintenance position of 10 |
| T | supporting structure |
| T2 | further supporting structure |
| U | ground surface |
| V | supply line |
| X | pivot axis |

1. A charging apparatus for electric vehicles, comprising:
a pivot arm with a plurality of longitudinal beam portions and a free end, wherein the plurality of longitudinal beam portions are fixed to one another and are provided for pivotable attachment to a supporting structure;
a charging cable which is guided over the pivot arm and over the free end and which can be connected to an electric vehicle; and
a remote-controllable device for pivoting the pivot arm about a pivot axis for height adjustment of the free end.

2. The charging apparatus according to the claim 1, wherein,
the pivot arm tapers from the pivot axis towards the free end.

3. The charging apparatus according to the claim 2, wherein:
the plurality of longitudinal beam portions have two first longitudinal beam portions which point towards the pivot axis and intersect the pivot axis,
the plurality of longitudinal beam portions are arranged to extend in a common plane, and
the plurality of longitudinal beam portions are connected to one another at least in a crossing area located between the free end and the pivot axis.

4. The charging apparatus according to the claim 3, wherein:
the plurality of longitudinal beam portions have a further longitudinal beam portion connected to the first longitudinal beam portions in the crossing area,
the further longitudinal beam portion provides the free end, and
the first longitudinal beam portions and the further longitudinal beam portion extend along the common plane and are arranged in a Y-shape.

5. The charging apparatus according to claim 3, wherein:
the first longitudinal beam portions are connected to one another by means of at least one transverse beam portion of the pivot arm, and
the plurality of longitudinal beam portions and the at least one transverse beam portion are rigidly connected to each other.

6. The charging apparatus according to claim 1, wherein;
the remote-controllable device includes a cable winch which is fixed to the pivot arm and which is provided for attachment to the supporting structure or a further supporting structure, wherein:
the cable winch is fixed to the pivot arm on the one hand between the free end and the pivot axis and on the other hand is provided for attachment above the pivot axis.

7. The charging apparatus according to claim 1, wherein:
at least one mechanical securing means is provided, which yields and/or is destroyed when a load limit is exceeded, in order to release and/or intercept a part of the charging apparatus, away from the pivot axis in the event of an overload.

8. The charging apparatus according to claim 7, wherein:
no cable drum is provided on the pivot arm and the charging apparatus includes a remote control for controlling the remote-controllable device for height adjustment of the free end.

9. The charging apparatus according to claim 1, wherein:
the pivot arm is provided with a connection device for connection to the charging cable,
wherein the pivot arm is provided with a plurality of connection devices and/or is provided for connecting a plurality of charging cables.

10. The charging apparatus according to claim 9, wherein;
a plug-in direction of the connection device points along the longitudinal beam portions and/or towards the free end,
a plug-in connection between the connection device and the charging cable can be released by a tensile force in the plug-in direction, and
the charging cable is deflected longitudinally at the free end.

11. The charging apparatus according to claim 1, wherein the pivot arm;
is intended for mounting at a height of at least 2 m and up to 8 m, and
includes a length of at least 5 m and up to 14 m.

12. As arrangement with a plurality of charging apparatuses, each of which is designed according to claim 1, wherein:
at least some or all of the plurality of charging apparatuses are arranged or are to be arranged side by side and with substantially coaxially aligned pivot axes to form a common pivot axis, and/or
at least some or all of the plurality of charging apparatuses are arranged or are to be arranged opposite one another and with substantially parallel pivot axes.

13. A system with a supporting structure and with at least one charging apparatus attached to the supporting structure the charging apparatus is designed according to claim 1, wherein:
the system comprises a building formed with the supporting structure, and/or
several of the charging apparatuses are attached to the supporting structure and/or are provided for pivoting about a/the common pivot axis in order to connect electric vehicles parked next to one another to the charging apparatuses.

14. (canceled)

15. A method for pivoting a pivot arm of a charging apparatus according to claim 1, wherein:
the remote-controllable device is actuated by means of a remote control in order to pivot the pivot arm about the pivot axis, and
the free end is adjusted in height by pivoting.
